(19) United States
(12) Patent Application Publication
(10) Pub. No.: US 2017/0176210 A1
(43) Pub. Date: Jun. 22, 2017

(54) VEHICLE NAVIGATION SYSTEM THAT PROVIDES LOCATION ACCESSIBILITY INFORMATION

(71) Applicant: JAGUAR LAND ROVER LIMITED, Warwickshire (GB)

(72) Inventors: Matt Jones, Portland, OR (US); Paul Wheller, Portland, OR (US); Peter Bontrager, Portland, OR (US)

(21) Appl. No.: 14/972,772

(22) Filed: Dec. 17, 2015

(51) Int. Cl. G01C 21/36; G01C 21/34

(52) U.S. Cl. CPC G01C 21/3679; G01C 21/3476; G01C 21/3644; G01C 21/3484

(57) ABSTRACT

An illustrative example vehicle navigation system includes a controller and a user interface. The user interface receives user input regarding at least one criterion of interest to the user and a desired area within which to identify a location satisfying that criterion. The controller determines a current vehicle position and direction. The controller identifies a place of potential interest as any location that satisfies the at least one criterion and is within the desired area relative to the current position of the vehicle. The controller determines a travel time from the current position of the vehicle to an identified place of potential interest. The controller determines if the place of potential interest will be accessible to the user based on the travel time. The user interface provides an output at least on a display screen including an indication whether the identified place of potential interest is accessible to the user.

### TECHNICAL FIELD

The present disclosure relates to providing information to assist a driver to decide whether potential locations of interest are accessible while driving in a vicinity of such locations. Aspects of the invention relate to a system, a vehicle and a method.

### BACKGROUND

With advances in computing technology, it has become increasingly possible to incorporate information and entertainment devices on vehicles. Navigation systems are one example that rely upon computing technology for providing automated route guidance to a driver. Such systems have proven useful and have gained widespread acceptance. Some such systems provide the ability for an individual to search for locations based on a category, for example. User experience with such systems can be less than satisfactory because of the limitations on how the user may make a request and the way in which information is provided to the user. Additionally, the amount of user involvement required for making such a request can make it challenging except when the vehicle is stationary and the individual is not actively driving the vehicle.

Another shortcoming of such systems is that the amount of information regarding a location identified in such a search is typically limited to an identity of the location and an approximate distance to the location.

It would be beneficial to be able to provide additional information through a vehicle navigation system in a way that meets an individual's desires or needs in a more convenient and effective manner.

### SUMMARY OF THE INVENTION

Aspects and embodiments of the invention provide a system, a method and a vehicle as claimed in the appended claims.

According to an aspect of the invention, there is provided a vehicle navigation system comprising a control means and a user interface means. The user interface means receives user input regarding at least one criterion of interest to the user and a desired area within which to identify a location satisfying the at least one criterion. The control means controls the user interface means based at least on the user input. The control means determines a current position and direction of a vehicle associated with the system. The control means identifies a place of potential interest as any location that satisfies the at least one criterion and is within the desired area relative to the current position of the vehicle. The control means determines a travel time from the current position of the vehicle to an identified place of potential interest. The control means determines if the place of potential interest will be accessible to the user based on the travel time. The control means causes the user interface means to provide an output at least on a display screen of the user interface means. The output includes an indication whether the identified place of potential interest is accessible to the user.

In an example embodiment having one or more features of the system of the previous paragraph, the control means comprises a computing device including at least one processor and memory associated with the computing device. The user interface means comprises at least the display screen and may include a speaker for providing audio output. The user interface means includes an input device that allows a user to provide input to the system.

In an example embodiment having one or more features of the system of any of the previous paragraphs, the control means determines if the identified place of interest is accessible to the user at an estimated time of arrival of the vehicle at the identified place of interest and the estimated time of arrival is based on the determined travel time and a current time.

In an example embodiment having one or more features of the system of any of the previous paragraphs, the travel time is determined based on a travel distance along a potential route between the current position of the vehicle and the identified place of interest.

In an example embodiment having one or more features of the system of any of the previous paragraphs, the travel time is determined based on traffic conditions along a potential route between the current position of the vehicle and the identified place of interest.

In an example embodiment having one or more features of the system of any of the previous paragraphs, the indication of the output includes a first type of indication when the identified place of interest is accessible to the user, the indication of the output includes a second type of indication when the identified place of interest is not accessible to the user and the second type of indication is different than the first type of indication.

In an example embodiment having one or more features of the system of any of the previous paragraphs, the control means determines whether the identified place of interest is accessible to the user based on information from a remotely accessible database and the information from the remotely accessible database includes information regarding hours of operation of the identified place of interest.

In an example embodiment having one or more features of the system of any of the previous paragraphs, the indication of the output is only provided regarding an identified place of interest that is accessible to the user.

In an example embodiment having one or more features of the system of any of the previous paragraphs, the output includes an indication of the current position of the vehicle and an indication of a position of any identified place of potential interest relative to the current position of the vehicle.

In an example embodiment having one or more features of the system of any of the previous paragraphs, the control means dynamically updates a position of the desired area based on changes in the current position of the vehicle, dynamically identifies any places of potential interest based on the updated desired area and dynamically updates the indication whether the identified place of interest is accessible to the user.

In an example embodiment having one or more features of the system of any of the previous paragraphs, the user interface means receives user input indicating a desire for more information regarding the identified place of interest, the control means causes the user interface means to provide additional information regarding the selected one of the places and the additional information comprises at least one of an indication of the travel distance, an indication of the travel time, an indication of a closing time of the identified place of interest, and an estimated wait time at the identified place of interest.

According to another aspect of the invention, there is provided a vehicle comprising the system of any of the previous paragraphs.

According to another aspect of the invention, there is provided a method of providing information to a driver of a vehicle through a vehicle navigation system user interface that includes at least a display screen. The method comprises receiving user input regarding at least one criterion of interest to the user and a desired area within which to identify a location satisfying the at least one criterion, determining a current position and direction of travel of the vehicle, identifying a place of potential interest as any location that satisfies the at least one criterion and is within the desired area relative to the current position of the vehicle, determining a travel time from the current position of the vehicle to an identified place of potential interest, determining if the place of potential interest will be accessible to the user based on the travel time, and providing an output at least on the display screen with the output including an indication whether the identified place of potential interest is accessible to the user.

An example embodiment having one or more features of the method of the previous paragraph includes determining if the identified place of interest is accessible to the user at an estimated time of arrival of the vehicle at the identified place of interest, wherein the estimated time of arrival is based on the determined travel time and a current time.

An example embodiment having one or more features of the method of any of the previous paragraphs includes determining the travel time based on a travel distance along a potential route between the current position of the vehicle and the identified place of interest.

An example embodiment having one or more features of the method of any of the previous paragraphs includes determining the travel time based on traffic conditions along a potential route between the current position of the vehicle and the identified place of interest.

In an example embodiment having one or more features of the method of any of the previous paragraphs, the indication of the output includes a first type of indication when the identified place of interest is accessible to the user, the indication of the output includes a second type of indication when the identified place of interest is not accessible to the user and the second type of indication is different than the first type of indication.

An example embodiment having one or more features of the method of any of the previous paragraphs includes determining whether the identified place of interest is accessible to the user based on information from a remotely accessible database that includes information regarding hours of operation of the identified place of interest.

An example embodiment having one or more features of the method of any of the previous paragraphs includes providing the indication of the output only regarding an identified place of interest that is accessible to the user.

In an example embodiment having one or more features of the method of any of the previous paragraphs, the output includes an indication of the current position of the vehicle and an indication of a position of any identified place of potential interest relative to the current position of the vehicle.

An example embodiment having one or more features of the method of any of the previous paragraphs includes dynamically updating a position of the desired area based on changes in the current position of the vehicle, dynamically identifying any places of potential interest based on the updated desired area, and dynamically updating the indication whether the identified place of interest is accessible to the user.

An example embodiment having one or more features of the method of any of the previous paragraphs includes receiving user input indicating a desire for more information regarding the identified place of interest and providing additional information regarding the selected one of the places based on the user input, wherein the additional information comprises at least one of an indication of the travel distance, an indication of the travel time, an indication of a closing time of the identified place of interest, and an estimated wait time at the identified place of interest.

According to another aspect of the invention there is provided a vehicle comprising a controller and the display screen configured to perform the method of any of the previous paragraphs.

According to another aspect of the invention, there is provided a vehicle navigation system comprising a controller including at least a processor and memory associated with the processor and a user interface that is controlled by the controller, the user interface including at least a display screen. The user interface receives user input regarding at least one criterion of interest to the user and a desired area within which to identify a location satisfying the at least one criterion. The controller determines a current position and direction of a vehicle associated with the system. The controller identifies a place of potential interest as any location that satisfies the at least one criterion and is within the desired area relative to the current position of the vehicle. The controller determines a travel time from the current position of the vehicle to an identified place of potential interest. The controller determines if the place of potential interest will be accessible to the user based on the travel time. A controller causes the user interface to provide an output at least on the display screen. The output includes an indication whether the identified place of potential interest is accessible to the user.

Within the scope of this document it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 diagrammatically illustrates an example embodiment of a system designed according to an embodiment of this invention associated with a vehicle;

FIG. 2 schematically illustrates selected portions of the example system of FIG. 1;

FIG. 3 is a flowchart diagram summarizing an example approach;

FIGS. 4A and 4B diagrammatically illustrate an example type of user output provided according to an embodiment of this invention; and

FIG. 5 illustrates another example type of output provided to a user according to an embodiment of this invention.

### DETAILED DESCRIPTION

Embodiments of this invention provide information to an individual within a vehicle to assist that individual in locating and traveling to places of potential interest in a customizable manner.

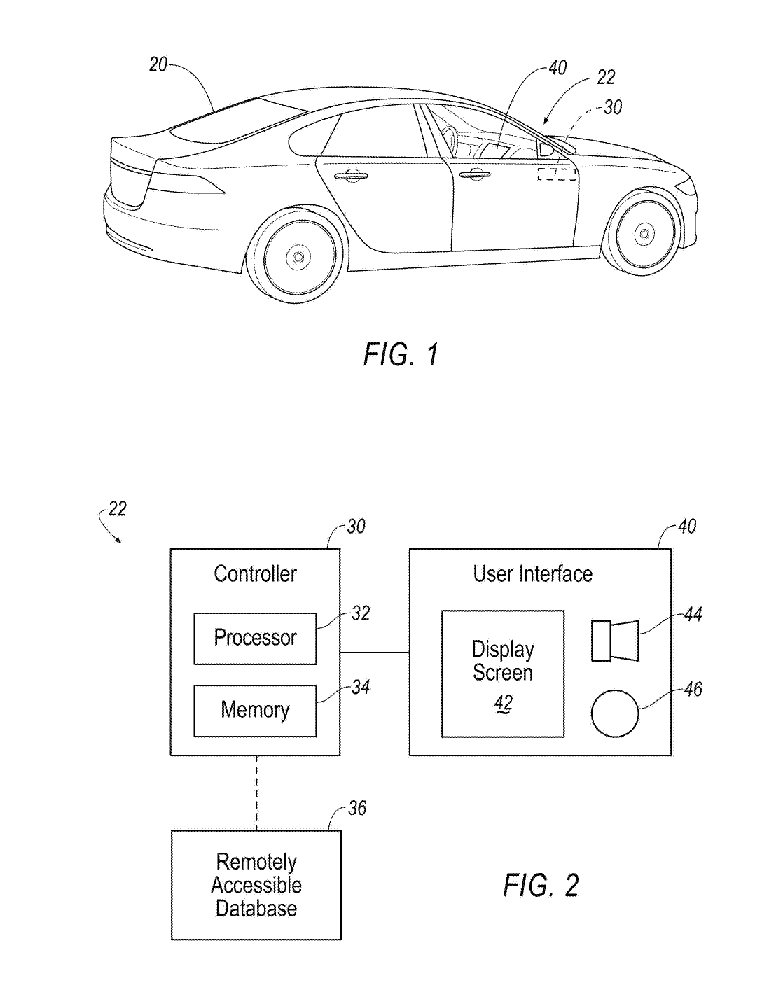

Referring to FIGS. 1 and 2, a vehicle 20 has an associated navigation system 22. A control means 30 includes at least one computing device 32, such as an electronic controller or a processor, and memory 34 associated with the computing device. The computing device 32 is particularly configured to perform functions and automate determinations associated with a vehicle navigation system. The control means 30 is capable of processing navigation information using known techniques.

For discussion purposes, the control means 30 may be referred to as a controller in the following description.

The computing device 32 can comprise a control unit or computational device having one or more electronic processors (e.g., a microprocessor, a microcontroller, an application specific integrated circuit (ASIC), etc.), and may comprise a single device or multiple devices that collectively operate as the computing device 32. The term “controller,” “control unit,” or “computational device” may include a single controller, control unit, or computational device, and a plurality of controllers, control units, or computational devices collectively operating to provide the required control functionality. A set of instructions is provided in some embodiments which, when executed, cause the controller to implement the control techniques mentioned in this description (including some or all of the functionality required for the described method). The set of instructions could be embedded in one or more electronic processors of the computing device; or alternatively, the set of instructions could be provided as software to be executed in the computing device. Given this description those skilled in the art will realize what type of hardware, software, firmware, or a combination of these will best suit their particular needs.

The memory 34 may be on board the vehicle 20, a remotely accessible data storage, or a combination of on board and remote memory.

The controller 30 has access to a remotely accessible database 36 as schematically shown in FIG. 2. The database 36 includes information regarding a variety of businesses, enterprises and other establishments, such as municipal parks. In one example, the database 36 is available over the Internet. In some examples, the database 36 is available through a subscription service. In some examples, the controller 30 has access to multiple databases with at least one of them being available over the Internet and at least one other being available through a subscription service.

The type of information included in the database 36 allows the controller 30 to determine when a particular location is open for business or otherwise accessible to the public. For example, a restaurant or retail store has typical hours of business during which that establishment is open. In some cases, the database 36 is dynamically updated to reflect a current status (e.g., open or closed) of such an establishment.

A user interface means 40 includes at least a display screen 42 that provides a visual output to an individual within the vehicle 20. An audio output or speaker 44 is provided in the illustrated example to provide audible indications regarding information of use or interest to an individual within the vehicle 20. The example user interface means 40 includes an input mechanism 46, such as a keypad, dial, switch, or pointer device, to facilitate the user providing input to the system 22.

According to an example embodiment, the display screen 42 is a touch screen that is configured to detect a user gesture near the screen utilizing known close proximity or contact sensing techniques. In this example, the display screen 42 serves as an output and input device of the user interface means 40.

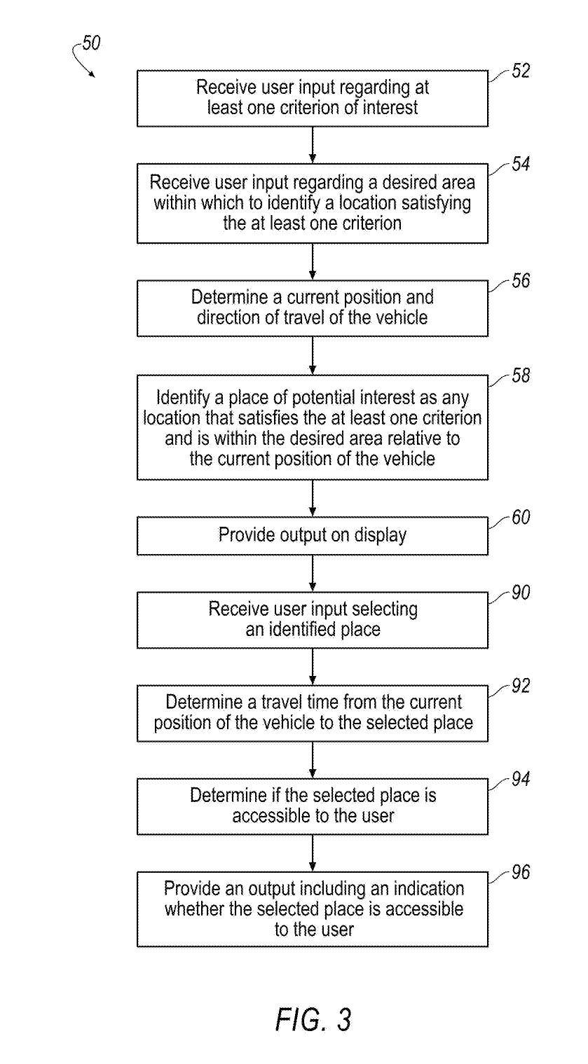

FIG. 3 is a flowchart diagram 50 summarizing an example method of providing information to an individual in the vehicle 20 through the navigation system 22. At 52, the system 22 receives user input through the user interface 40 regarding at least one criterion of interest to the user. The user input may specify particular types of business establishments, for example, that the individual would like to know about while in the vehicle 20.

At 54, the user provides input regarding a desired area within which to identify a location satisfying the at least one criterion. The desired area may be defined in terms of a geographic distance, such as a search radius or range from a current position of the vehicle 20. The desired area may also be defined in terms of a maximum acceptable or desirable travel distance, which takes into account information regarding a potential route from a current vehicle location to the location of a place of interest based on the criterion established by the user. A geographic distance and a travel distance may be different or the same depending on the configuration of road surfaces available to an individual for traveling from a current vehicle position to the position of a place of interest. The illustrated example embodiment allows a user to customize the size of the desired area based on geographic distance or travel distance.

Another way in which the desired area may be defined in this example embodiment is by travel time between a current vehicle location and the location of a place of interest that satisfies the at least one criterion input by the user. In some instances, an individual may not be concerned with the actual distance as much as being concerned with how long it will take to travel from a current vehicle position, which may be along a desired route to an intended destination, to a place of potential interest identified by the system 22. For example, a driver may not want to deviate from a current route for more than ten minutes. The illustrated example allows an individual to set the range or limit of the desired area based upon travel time.

Some embodiments use a combination of time and distance information to set or determine the size, scope or range of the desired area.

At 56, the controller 30 determines a current position and direction of travel of the vehicle 20. In one example, the controller 30 utilizes known global positioning and navigation techniques for making the determinations at 56.

At 58, the controller 30 identifies any location that satisfies the at least one criterion and is within the desired area as a place of potential interest. In this example, the controller 30 gathers information from the database 36, which includes information regarding various establishments. When the desired area includes the location of a business (and it meets the user's criterion), that business is identified as a place of potential interest. At 60, the controller 30 causes the user interface 40 to provide an output at least on the display screen 42 indicating the desired area and any identified place of potential interest within the desired area.

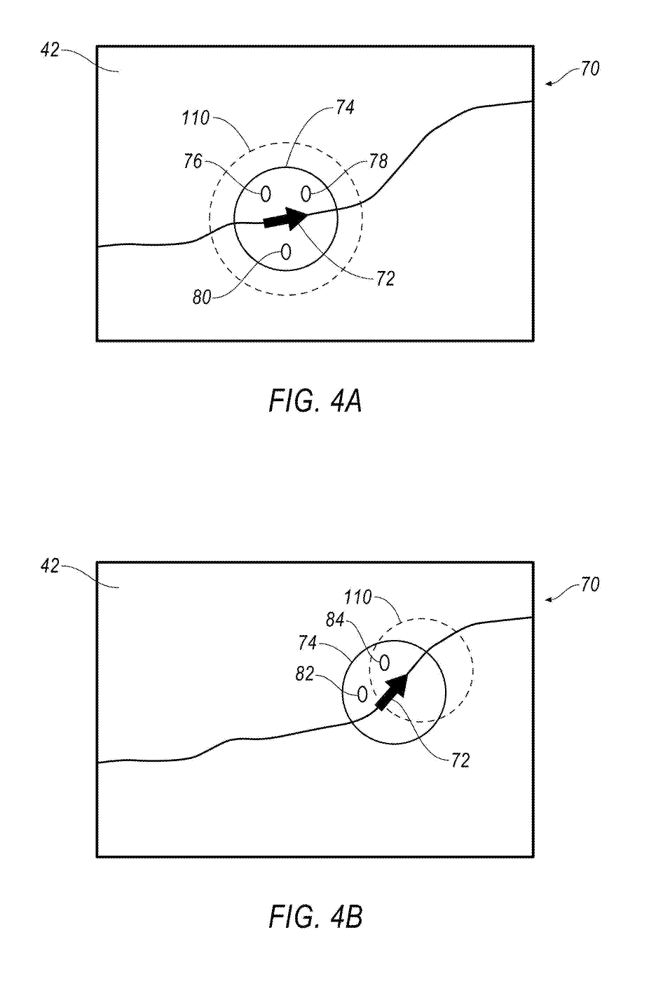

As shown in FIG. 4A, an example display output 70 includes an indication of the current position of the vehicle at 72. The desired area is shown at 74. In the illustrated example, the desired area 74 is represented by a circle that surrounds the current position of the vehicle 72. The actual configuration of the desired area may be different than a circle when the desired area is defined in terms of actual travel distance or travel time. For simplicity and aesthetic reasons, the desired area 74 may be represented as a circle for informing the user of the approximate range of the desired area. Other shapes that represent the desired area are useful in some embodiments.

The example output 70 includes indications of several places of potential interest shown at 76, 78 and 80. The symbol or indication of the identified places of potential interest may have a variety of shapes or colors depending on the particular type of establishment, for example.

Comparing FIG. 4B to FIG. 4A, the current position of the vehicle 72 is different in FIG. 4B. The controller 30 continuously and dynamically updates the desired area 74 based upon the current position of the vehicle 72. Accordingly, the display shown in FIG. 4B includes the desired area 74 repositioned relative to the position of the desired area in FIG. 4A. Additionally, the controller 30 continuously and dynamically updates determinations regarding potential places of interest within the desired area 74. Two identified places of potential interest 82 and 84 are schematically shown in FIG. 4B, which were not within the desired area 74 when the vehicle was at the position 72 shown in FIG. 4A but are with the desired area 74 relative to the current location of the vehicle 72 in FIG. 4B.

One feature of the illustrated embodiment is an ability to provide an individual information that will assist that individual in making a decision whether to detour from a current route to one of the identified places of potential interest. Referring to FIG. 3, user input selecting an identified place is received by the system 22 at 90. The user may touch one of the representations or indications of an identified place of interest to provide input of a desire for more information regarding that place. Some embodiments allow for the user to speak the name or another identifier of one of the identified places of potential interest to provide audio input regarding a desire for more information regarding that place. Other embodiments have additional ways in which a user can provide such input.

At 92, the controller 30 determines a travel time from the current position of the vehicle to the selected place of interest. Determining the travel time in this example includes calculating a route from the current vehicle position to the location of the selected place of interest. Known navigation system techniques are used in one example for determining the travel time based on information regarding the determined route.

At 94, the controller 30 utilizes information from the remotely accessible database 36 (or information stored in the memory 34 if appropriate) to determine if the selected place of interest is accessible to the user. For example, the controller 30 utilizes the travel time determined at 92 and the current time of day to estimate an arrival time of the vehicle 20 at the selected place of interest. If the arrival time is within the hours within which that place of interest is open for business (based on the information from the database 36), the controller 30 determines that the place is accessible to the user.

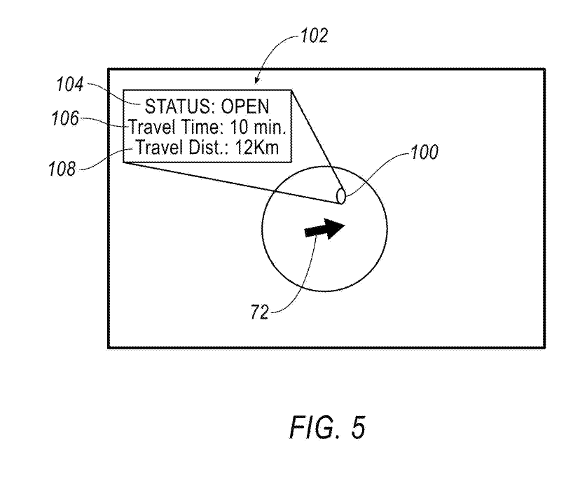

At 96, the controller 30 controls the user interface 40 to provide an output at least on the display screen 42 including an indication whether the selected place of interest is accessible to the user. FIG. 5 schematically illustrates one such example output. As can be appreciated from FIG. 5, an indication of the selected place of interest 100 is shown relative to the current position of the vehicle 72. An additional dialog box 102 is associated with the selected place of interest 100. In this example, the additional dialog box 102 provides an indication of the current status of that place of interest at 104, such as indicating that it is open or closed. The dialog box 102 in this example also includes an indication of the travel time (from the vehicle location to the place of interest) at 106 and the travel distance at 108.

The output regarding whether the selected place of interest is accessible to the user may take a variety of forms. Some examples include only providing additional information like that shown in the dialog box 102 when the controller 30 has determined that a particular place is accessible to the user. If the selected place of interest is not accessible, no additional information beyond the indication of that place is provided in such embodiments. Some embodiments will only show potential places of interest that have already been determined to be accessible to the user. For example, the controller 30 will not cause the display to include an indication of a place that is within the desired area but not currently open.

In some example embodiments, the information provided at 102 is different depending on the availability or accessibility of a selected place of interest. The status shown at 104 will say open when the place is accessible or closed when the place is not accessible. In some embodiments, the indicator of the place of interest 100 is color-coded depending on whether that place of interest is accessible. For example, when the place is accessible, the indicator of that place is at least partially colored green as an indication that the place is accessible. When the place is not accessible (or not going to be accessible at the estimated arrival of the vehicle 20 at that place), the indicator is at least partially colored red as an indication that the placed is not accessible to the user.

The type of information shown in the dialog box 102 in some examples is continuously updated for a predetermined period of time until the user selects a different place, indicates no further interest in that place (e.g., by de-selecting that place), or the selected place ceases to be within the desired area based upon continued movement of the vehicle.

Providing the output at 96 and as represented in FIG. 5 allows an individual to make an informed decision whether traveling to an identified place of potential interest is desirable at least based upon whether that place is accessible to the user at that time. Some embodiments include additional information within the output regarding a selected place of interest. For example, when information is available from the database 36 regarding a current or typical wait time at a particular business establishment, that information may be provided to the user through the output provided at 96. When such information is provided, the individual may determine how long of a detour traveling to that place will actually be based on the estimated travel time and estimated wait time.

Some examples include providing information to a user that indicates when an establishment is currently closed but will soon be opening. Such information may include an indication of the travel time and an indication of an approximate wait time between arrival and when the individual may enter the establishment.

The information provided at 102 in some embodiments includes an indication of a closing time or a remaining amount of time during which that establishment remains open. Such information allows an individual to determine whether they will have ample time available at that establishment to justify the detour to that place. For example, a particular store may be open for approximately ten minutes beyond the estimated arrival time at that place. If the individual knows that it will take them at least thirty minutes to complete necessary or desired shopping, the individual realizes that detouring from a current route to that place may not be useful at that particular time.

A variety of additional indicators or combinations of selected ones of the indicators described above may be provided in some embodiments. Some embodiments allow the vehicle owner to customize the way in which such information is provided to meet their particular needs. For example, some individuals will prefer less information and only want an indication of whether an establishment is open or closed as an indication of whether that place is accessible. Others will desire more information and may provide input to the system 22 so that the controller 30 customizes the way in which such information is provided to that individual.

Another feature of the illustrated example embodiment is that it allows for the user to customize the desired area within which to find places of potential interest. Considering FIG. 4A, the user may expand or contract the desired area 74 by providing input through the user interface 40. In an embodiment that includes a touch screen as the display screen 42, the user may perform a gesture with at least two fingers on or near the display screen 42. Assuming the user spreads two fingers apart close to or on the position of the desired area 74 on the display screen 42, the controller receives such input and interprets it as a desire to expand the desired area to a range as schematically shown at 110. Similarly, if a user were to bring two fingers closer together while touching or near the position of the desired area on the screen 42, the controller 30 will reduce the size, scope or range of the desired area.

FIG. 4B schematically shows another way in which the desired area may be customized to have a particular arrangement relative to the current position of the vehicle. In FIG. 4B, the user performs a gesture involving at least one finger to move the desired area relative to the current position of the vehicle 72. For example, consider an individual being more interested in places of potential interest the vehicle is approaching compared to places of potential interest that have recently been passed. An example user input to indicate a preference to arrange the desired area more forward of the vehicle may include placing one finger within close proximity to the current position of the vehicle 72 and using another finger to move the desired area relative to that current position. The controller 30 interprets such input received through the touch screen 42 as an indication to move the desired area from the arrangement shown at 74 to the arrangement shown at 110 in FIG. 4B.

A user may also customize the arrangement of the desired area relative to the current position of the vehicle utilizing other types of input to achieve other types of results. For example, the shape of the desired area may be changed.

Additionally, more information or other formats of information may be provided through the user interface 40. The example outputs of FIGS. 4A, 4B, and 5 demonstrate one example embodiment of an output that includes an indication of a desired area and information regarding accessibility of an identified place of potential interest.

The preceding description is illustrative rather than limiting in nature. Variations and modifications to the disclosed examples may become apparent to those skilled in the art that do not necessarily depart from the essence of the contribution to the art provided by the disclosed embodiments. The scope of legal protection can only be determined by studying the following claims.

We claim:

1. A vehicle navigation system, comprising:
user interface means for receiving user input regarding at least one criterion of interest to the user and a desired area within which to identify a location satisfying the at least one criterion; and
control means for controlling the user interface means based at least on the user input, wherein:
the control means determines a current position and direction of a vehicle associated with the system,
the control means identifies a place of potential interest as any location that satisfies the at least one criterion and is within the desired area relative to the current position of the vehicle,
the control means determines a travel time from the current position of the vehicle to an identified place of potential interest,
the control means determines if the place of potential interest will be accessible to the user based on the travel time, and
the control means causes the user interface means to provide an output at least on a display screen of the user interface means, the output including an indication whether the identified place of potential interest is accessible to the user.

2. The system of claim 1, wherein
the control means determines if the identified place of interest is accessible to the user at an estimated time of arrival of the vehicle at the identified place of interest; and
the estimated time of arrival is based on the determined travel time and a current time.

3. The system of claim 2, wherein the travel time is determined based on a travel distance along a potential route between the current position of the vehicle and the identified place of interest.

4. The system of claim 2, wherein the travel time is determined based on traffic conditions along a potential route between the current position of the vehicle and the identified place of interest.

5. The system of claim 1, wherein
the indication of the output includes a first type of indication when the identified place of interest is accessible to the user;
the indication of the output includes a second type of indication when the identified place of interest is not accessible to the user; and
the second type of indication is different than the first type of indication.

6. The system of claim 1, wherein
the control means determines whether the identified place of interest is accessible to the user based on information from a remotely accessible database; and
the information from the remotely accessible database includes information regarding hours of operation of the identified place of interest.

7. The system of claim 1, wherein the indication of the output is only provided regarding an identified place of interest that is accessible to the user.

8. The system of claim 1, wherein
the output includes an indication of the current position of the vehicle and an indication of a position of any identified place of potential interest relative to the current position of the vehicle.

9. The system of claim 1, wherein the control means dynamically updates a position of the desired area based on changes in the current position of the vehicle;
dynamically identifies any places of potential interest based on the updated desired area; and
dynamically updates the indication whether the identified place of interest is accessible to the user.

10. The system of claim 1, wherein
the user interface means receives user input indicating a desire for more information regarding the identified place of interest;
the control means causes the user interface means to provide additional information regarding the selected one of the places; and
the additional information comprises at least one of:
an indication of the travel distance,
an indication of the travel time,
an indication of a closing time of the identified place of interest, and
an estimated wait time at the identified place of interest.

11. A vehicle comprising the system of claim 1.

12. A method of providing information to a driver of a vehicle through a vehicle navigation system user interface that includes at least a display screen, the method comprising:
receiving user input regarding at least one criterion of interest to the user and a desired area within which to identify a location satisfying the at least one criterion;
determining a current position and direction of travel of the vehicle;
identifying a place of potential interest as any location that satisfies the at least one criterion and is within the desired area relative to the current position of the vehicle;
determining a travel time from the current position of the vehicle to an identified place of potential interest;
determining if the place of potential interest will be accessible to the user based on the travel time, and
providing an output at least on the display screen, the output including an indication whether the identified place of potential interest is accessible to the user.

13. The method of claim 12, comprising determining if the identified place of interest is accessible to the user at an estimated time of arrival of the vehicle at the identified place of interest, wherein the estimated time of arrival is based on the determined travel time and a current time.

14. The method of claim 13, comprising determining the travel time based on a travel distance along a potential route between the current position of the vehicle and the identified place of interest.

15. The method of claim 13, comprising determining the travel time based on traffic conditions along a potential route between the current position of the vehicle and the identified place of interest.

16. The method of claim 12, wherein
the indication of the output includes a first type of indication when the identified place of interest is accessible to the user;
the indication of the output includes a second type of indication when the identified place of interest is not accessible to the user; and
the second type of indication is different than the first type of indication.

17. The method of claim 12, comprising
determining whether the identified place of interest is accessible to the user based on information from a remotely accessible database that includes information regarding hours of operation of the identified place of interest.

18. The method of claim 12, comprising providing the indication of the output only regarding an identified place of interest that is accessible to the user.

19. The method of claim 12, wherein
the output includes an indication of the current position of the vehicle and an indication of a position of any identified place of potential interest relative to the current position of the vehicle.

20. The method of claim 12, comprising
dynamically updating a position of the desired area based on changes in the current position of the vehicle;
dynamically identifying any places of potential interest based on the updated desired area; and
dynamically updating the indication whether the identified place of interest is accessible to the user.

21. The method of claim 12, comprising
receiving user input indicating a desire for more information regarding the identified place of interest; and
providing additional information regarding the selected one of the places based on the user input, wherein the additional information comprises at least one of:
an indication of the travel distance,
an indication of the travel time,
an indication of a closing time of the identified place of interest, and
an estimated wait time at the identified place of interest.

22. A vehicle comprising a controller and the display screen configured to perform the method of claim 12.
